(19) United States
(12) Patent Application Publication
(10) Pub. No.: US 2016/0105287 A1
(43) Pub. Date: Apr. 14, 2016

(54) DEVICE AND METHOD FOR TRACEABLE GROUP ENCRYPTION

(71) Applicant: THOMSON LICENSING, Issy-les-Moulineaux (FR)

(72) Inventors: Marc JOYE, Palo Alto, CA (US); Benoit LIBERT, Lyon (FR)

(21) Appl. No.: 14/888,413

(22) PCT Filed: Apr. 30, 2014
(86) PCT No.: PCT/EP2014/058818

§ 371 Date: Oct. 30, 2015

(30) Foreign Application Priority Data
Apr. 30, 2013 (EP) 13305572.3

(51) Int. Cl. H04L 9/32; H04L 29/06; H04L 9/30

(52) U.S. Cl. CPC H04L 9/3255; H04L 9/3013; H04L 63/0428

(57) ABSTRACT

A group encryption system comprising at least one group member device, a group manager device, an opening authority device, a sender device and a tracing agent device. The sender device is configured to encrypt a plaintext using the public key of a group member. The group member device is configured to receive and decrypt the ciphertext using the corresponding private key, and also to claim or disclaim a ciphertext. The opening authority device is configured to disclose at least one user-specific trapdoor that makes it possible to trace, by the tracing agent device, all the ciphertexts for the specified user and only those ciphertexts.

### TECHNICAL FIELD

The present invention relates generally to cryptography and in particular to group encryption.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Group encryption schemes involve a sender, a verifier, a group manager (GM) that manages the group of receivers and an opening authority (OA) that is able to uncover the identity of receivers of ciphertext. A group encryption system GE is formally specified by the description of a relation [symbol] as well as a collection of algorithms and protocols: SETUP, JOIN, [symbol] [symbol] ᵣ, [symbol] , [symbol] [symbol] , ENC, DEC, [symbol] [symbol] , [symbol] [symbol] , OPEN, REVEAL, TRACE, CLAIM/DISCLAIM, CLAIM-VERIFY, DISCLAIM-VERIFY. Among these, SETUP is a set of initialization procedures SETUPᵢₙᵢₜ(λ) that take (explicitly or implicitly) a security parameter λ as input. The procedure can be split into a procedure that generates a set of public parameters param (a common reference string), one, SETUP_{GM}(param), for the so-called Group Manager GM and another, SETUP_{OA}(param), for the so-called Opening Authority OA. The latter two procedures are used to produce a key pair (pk_{GM}, sk_{GM}) for the GM and a key pair, (pk_{OA}, sk_{OA}) the OA. In the following, to simplify the description, the parameter param is not always explicitly stated as input to the algorithms.

JOIN=(Jᵤₛₑᵣ, J_{GM}) is an interactive protocol between the GM and a prospective user. As shown by Kiayias and Yung [see A. Kiayias and M. Yung. Group signatures with efficient concurrent join. In Eurocrypt'05, Lecture Notes in Computer Science 3494, pages 198-214, Springer, 2005.], this protocol can have minimal interaction and consist of only two messages: the first message comprising the user's public key pk sent by Jᵤₛₑᵣ to J_{GM} and the latter's response comprising a certificate certₚₖ for pk that makes the user's group membership effective. It is then not required for the user to, for example, prove knowledge of its private key sk. After the execution of JOIN, the GM stores the public key pk with its certificate certₚₖ and the whole transcript transcript of the conversation in a public directory database. It is assumed that anyone can check the well-formedness of the public directory (for example, the fact that no two distinct users share the same public key) by means of a deterministic algorithm DATABASE-CHECK, which returns 1 or 0 depending on whether public directory is deemed valid or not.

Algorithm sample allows sampling pairs (x, w) ∈ [symbol] (made of a public value x and a witness w using keys (pk [symbol] , sk [symbol] ) produced by [symbol] ᵣ. Depending on the relation, sk [symbol] may be the empty string. The testing procedure [symbol] (x,w) returns 1 whenever (x,w) ∈ [symbol] . To encrypt a witness w such that (x,w) ∈ [symbol] for some public x, the sender obtains the pair (pk, certₚₖ) from the public directory and runs a randomized encryption algorithm, which takes as input w, a label L, the receiver's pair (pk, certₚₖ) as well as public keys pk_{Gm} and pk_{OA}. Its output is a ciphertext ψ←ENC(pk_{GM},pk_{OA},pk,certₚₖ,w,L). On input of the same elements, the certificate certₚₖ, the ciphertext ψ and the random coins coins_{ψ} that were used to produce it, the non-interactive algorithm [symbol] generates a proof π_{ψ} that there exists a certified receiver whose public key was registered in public directory and that is able to decrypt and obtain a witness w such that (x,w) ∈ [symbol] . The verification algorithm [symbol] takes as input the ciphertext ψ, the public keys pk_{GM}, pk_{OA}, the proof π_{ψ} and the description of [symbol] , and outputs 0 or 1. Given the ciphertext ψ, the label L and the receiver's private key sk, the output of DEC is either a witness w such that (x, w) ∈ [symbol] or a rejection symbol ⊥.

The next three algorithms provide explicit and implicit tracing capabilities. First, OPEN takes as input a ciphertext/label pair (ψ, L) and the OA's secret key sk_{OA} and returns a receiver's identity i and its public key pk. Algorithm REVEAL takes as input the joining transcript transcript of user i and allows the OA to extract a tracing trapdoor traceᵢ using its private key sk_{OA}. This tracing trapdoor can be subsequently used to determine whether or not a given ciphertext-label pair (ψ, L) is a valid encryption under the public key pk, of user i: namely, algorithm TRACE takes in public keys pk_{GM} and pk_{OA} as well as the pair ciphertext-label pair (ψ, L) and the tracing trapdoor traceᵢ associated with user i. It returns 1 if and only if the ciphertext-label pair (ψ, L) is believed to be a valid encryption intended for user i. It is particularly noted that the tracing trapdoor traceᵢ only allows testing whether the receiver is user i: in particular, it does not allow decryption of the ciphertext-label pair (ψ, L) and it does not reveal the receiver's identity.

The last three algorithms (CLAIM/DISCLAIM, CLAIM-VERIFY, DISCLAIM-VERIFY) implement functionality that allows user to convincingly claim or disclaim being the legitimate recipient of a given anonymous ciphertext. Concretely, CLAIM/DISCLAIM takes as input the public keys (pk_{GM}, pk_{OA}, pk), a ciphertext-label pair (ψ, L) and a private key sk. It reveals a publicly verifiable piece of evidence τ that the ciphertext-label pair (ψ, L) is or is not a valid encryption under the public key pk. Algorithms CLAIM-VERIFY and DISCLAIM-VERIFY are then used to verify the assertion established by the evidence τ. They take as input the public keys, the ciphertext-label pair (ψ,L) and a claim/disclaimer τ and output 1 or 0.

Kiayias, Tsiounis and Yung (KTY) [see A. Kiayias, Y. Tsiounis, and M. Yung. Group encryption. In Asiacrypt'07, Lecture Notes in Computer Science 4833, pages 181-199, Springer, 2007.] formalized the concept of group encryption and provided a suitable security model (including four properties called ‘correctness’, ‘message security’, ‘anonymity’ and ‘soundness’). They presented a modular design of GE system and proved that, beyond zero-knowledge proofs, anonymous public key encryption schemes with adaptive chosen-ciphertext (CCA2) security, digital signatures, and equivocal commitments are necessary to realize the primitive. They also showed how to efficiently instantiate their general construction using Paillier's cryptosystem [see P. Paillier. Public-key cryptosystems based on composite degree residuosity classes. In Eurocrypt'99, Lecture Notes in Computer Science 1592, pages 223-238, Springer, 1999.]. While efficient, the scheme is not a single-message encryption scheme, since it requires the sender to interact with the verifier in an online 3-move conversation (or “Σ-protocol”) to be convinced that the aforementioned properties are satisfied. Interaction can be removed using the Fiat-Shamir paradigm [see A. Fiat and A. Shamir. How to prove yourself: Practical solutions to identification and signature problems. In Crypto'86, Lecture Notes in Computer Science 263, pages 186-194, Springer, 1986.] (and thus the random oracle model [see M. Bellare and P. Rogaway. Random oracles are practical: A paradigm for designing efficient protocols. In ACM CCS'93, pages 62-73, ACM Press, 1993.]), but only heuristic arguments [see S. Goldwasser and Y. Tauman-Kalai. On the (In)security of the Fiat-Shamir Paradigm In FOCS'03, pages 102-115, IEEE Press, 2003. and also [R. Canetti, O. Goldreich, and S. Halevi. The random oracle methodology, revisited. Journal of the ACM, 51(4):557-594, 2004.] are then possible in terms of security.

Independently, Qin et al. [B. Qin, Q. Wu, W. Susilo, Y. Mu, Y. Wang. Publicly Verifiable Privacy-Preserving Group Decryption. In Inscrypt'08, Lecture Notes in Computer Science 5487, pages 72-83, Springer, 2008.] considered a closely related primitive with non-interactive proofs and short ciphertexts. However, they avoid interaction by explicitly employing a random oracle and also rely on strong interactive assumptions.

Recently, El Aimani and Joye [L. El Aimani, M. Joye. Toward Practical Group Encryption. Cryptology ePrint Archive: Report 2012/155, 2012.] considered more efficient interactive and non-interactive constructions using various optimizations.

However, as it turns out, none of the above constructions makes it possible to trace a specific user's ciphertexts and only those. In these constructions, if messages encrypted for a specific misbehaving user have to be identified within a collection of, say n=10000 ciphertexts, then the opening authority has to open all of these in order to find those it is looking for. This is clearly harmful to the privacy of honest users. Kiayias, Tsiounis and Yung [see A. Kiayias, Y. Tsiounis, and M. Yung. Traceable signatures. In Eurocrypt 2004, Lecture Notes in Computer Science 3027, pages 571-589. Springer, 2004.] suggested a technique to address this concern in the context of group signatures, but no real encryption analogue of their primitive has been provided so far.

The closest work addressing this problem is that of Izabachene, Pointcheval and Vergnaud [M. Izabachene, D. Pointcheval, D. Vergnaud. Mediated Traceable Anonymous Encryption. In Latincrypt'08, Lecture Notes in Computer Science 6212, pages 40-60, Springer, 2010.]. However, their “mediate traceable anonymous encryption” primitive is somewhat limited. First, their scheme only provides message confidentiality and anonymity against passive adversaries, who have no access to decryption oracles at any time. Second, while their constructions enable individual user traceability, they do not provide a mechanism allowing the authority to identify the receiver of a ciphertext in O(1) time. If their scheme is set up for groups of up to n users, their opening algorithm requires O(n) operations in the worst case. Finally, their schemes provide no method allowing users to claim or disclaim that they are the recipients of ciphertexts without disclosing their private keys.

It will thus be appreciated that there is a need for a solution that overcomes at least some of the drawbacks of the scheme of Izabachene et al., in particular a solution that simultaneously: (i) allows tracing specific users' ciphertexts and only those; and (ii) provides an explicit opening algorithm which can identify the receiver of a ciphertext in O(1) time. The present invention provides such a solution.

### SUMMARY OF INVENTION

In a first aspect, the invention is directed to an device for encrypting a plaintext destined for a user having a public key. The device comprises a processor configured to: obtain a tuple of traceability components for first elements of the public key; encrypt, using encryption exponents and second elements of the public key, the plaintext under a label to obtain a first intermediary ciphertext; generate commitments to the encryption exponents; generate second intermediary ciphertexts by encrypting the first elements of the user's public key under a public key of an opening authority using a verification key; and generate, using a signature key, a signature over the tuple of traceability components, the first intermediary ciphertext, and the second intermediary ciphertexts. The device further comprises an interface configured to output a ciphertext comprising the tuple of traceability components, the first intermediary ciphertext, the second intermediary ciphertexts, and the signature.

In a first embodiment, the processor is configured to obtain the traceability components by calculating a plurality of values, wherein each value is obtained by taking a generator or an element of the public key to the power of a value involving at least one random number.

In a second embodiment, the public key comprises a Diffie-Hellman instance and wherein the tracability components enable recognition of the public key through the solution to the Diffie-Hellman instance.

In a third embodiment, the first intermediary ciphertext is obtained by multiplication between the plaintext and elements of the public key raised to the power of encryption exponents.

In a fourth embodiment, the verification key is a verification key of a one-time signature scheme. It is advantageous that the signature is a one-time signature obtained using the one-time signature scheme.

In a fifth embodiment, wherein the signature is generated also over a label, and the interface is further configured to output the label.

In a second aspect, the invention is directed to a method for encrypting a plaintext destined for a user having a public key. A processor obtains a tuple of traceability components for first elements of the public key; encrypts, using encryption exponents and second elements of the public key, the plaintext under a label to obtain a first intermediary ciphertext; generates commitments to the encryption exponents; generates second intermediary ciphertexts by encrypting the first elements of the user's public key under a public key of an opening authority using a verification key; and generates, using a signature key, a signature over the tuple of traceability components, the first intermediary ciphertext, and the second intermediary ciphertexts. An interface outputs a ciphertext comprising the tuple of traceability components, the first intermediary ciphertext, the second intermediary ciphertexts, and the signature.

In a first embodiment, the traceability components are obtained by calculating a plurality of values, wherein each value is obtained by taking a generator or an element of the public key to the power of a value involving at least one random number.

In a second embodiment, the first intermediary ciphertext is obtained by multiplication between the plaintext and elements of the public key raised to the power of encryption exponents.

In a third embodiment, the verification key is a verification key of a one-time signature scheme. It is advantageous that the signature is a one-time signature obtained using the one-time signature scheme.

In a fourth embodiment, the signature is generated also over a label, and the label is further output by the interface.

### BRIEF DESCRIPTION OF DRAWINGS

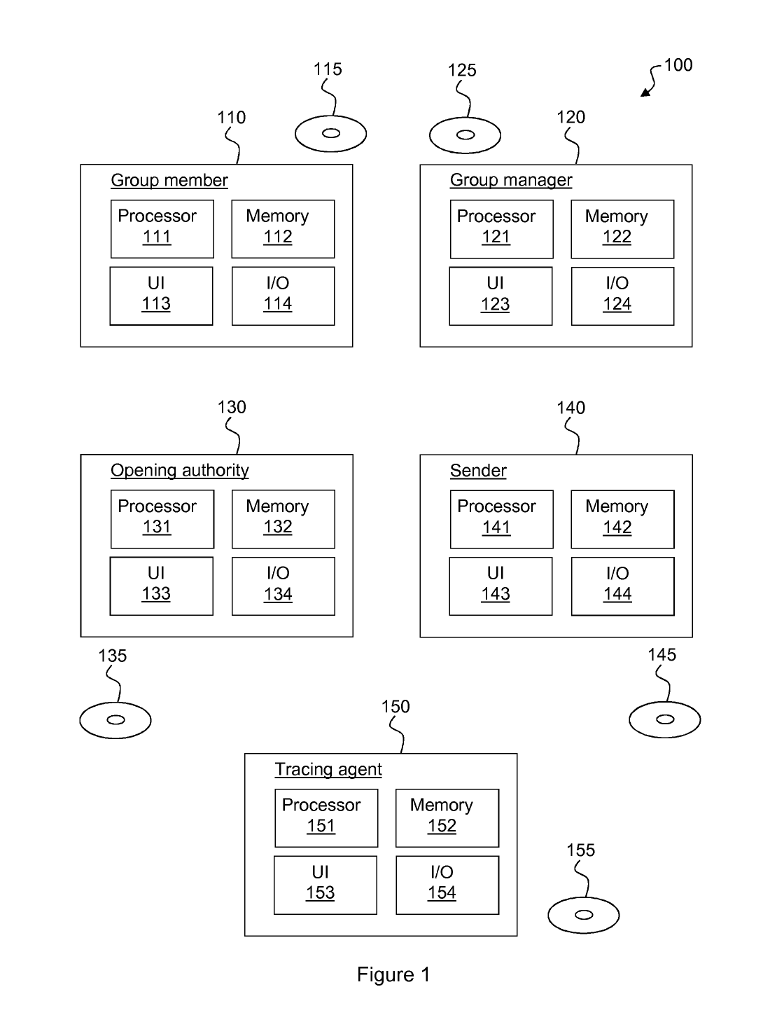

Preferred features of the present invention will now be described, by way of non-limiting example, with reference to the accompanying drawings, in which FIG. 1 illustrates an exemplary system in which the invention may be implemented.

### DESCRIPTION OF EMBODIMENTS

FIG. 1 illustrates an exemplary system 100 in which the invention may be implemented. The system comprises a device of a group member (“group member”) 110, a group manager device 120, an opening authority (OA) device 130, a sender device 140 and a tracing agent device 150. It will be understood that there normally is more than one group member device, but only one is illustrated in the Figure. These devices can be any kind of suitable computer or device capable of performing calculations, such as a standard Personal Computer (PC) or workstation. The devices each preferably comprise at least one processor 111, 121, 131, 141, 151, RAM memory 112, 122, 132, 142, 152, a user interface 113, 123, 133, 143, 153, for interacting with a user, and a second interface 114, 124, 134, 144, 154 for interaction with other devices (such as those shown in the Figure) over some connection (not shown). The group member device 110 is configured to, among other things, join a group, receive and decrypt ciphertexts, and claim or disclaim a ciphertext, as described hereinafter. The group manager device 120 is configured to perform group manager functions described hereinafter. The opening authority device 130 is configured to disclose user-specific trapdoors, as described hereinafter. The sender device 140 is configured to encrypt a plaintext using a public key of a group member and output the resulting ciphertext to the group member, as described hereinafter. The tracing agent device 150 is configured to use user-specific trapdoors to trace ciphertexts for specified users. The devices also preferably comprise an interface for reading a software program from a non-transitory digital data support—115, 125, 135, 145, and 155 respectively—that stores instructions that, when executed by a processor, performs the corresponding methods described hereinafter. The skilled person will appreciate that the illustrated devices are very simplified for reasons of clarity and that real devices in addition would comprise features such as persistent storage.

A main inventive idea of the present invention is enabling the OA to disclose user-specific trapdoors, which make it possible to trace all the ciphertexts encrypted for that user and only those ciphertexts. To this end, a pair (Γ₁, Γ₂) is included in each membership certificate; (Γ₁, Γ₂)=(g^{γ}^{₁}, g^{γ}^{₂}) ∈ [symbol] ², where (γ₁, γ₂) ∈ [symbol] ₚ² are part of the user's private key. When users join the group, they are thus requested to produce a pair (Γ₁, Γ₂)=(g^{γ}^{₁}, g^{γ}^{₂}) for which g^{γ}^{₁}^{γ}^{₂} will serve as a tracing trapdoor. Since g^{γ}^{₁}^{γ}^{₂} cannot be publicly revealed, appeal is made to a verifiable encryption mechanism [see J. Camenish, V. Shoup. Practical Verifiable Encryption and Decryption of Discrete Logarithms. In Crypto 2003, Lecture Notes in Computer Science 2729, pages 126-144, Springer, Springer, 2003.] as was suggested by Benjumea et al. [see V. Benjumea, S.-G. Choi, J. Lopez, M. Yung. Fair Traceable Multi-Group Signatures. In Financial Cryptography 2008, Lecture Notes in Computer Science 5143, pages 231-246, Springer, 2008.] in a related context: namely, the prospective user provides the GM with an encryption Φ_{venc} of g^{γ}^{₁}^{γ}^{₂} under the OA's public key and generates a non-interactive proof that the encrypted value is indeed an element g^{γ}^{₁}^{γ}^{₂} such that (g,g^{γ}^{₁}, g^{γ}^{₂}, g^{γ}^{₁}^{γ}^{₂}) is a Diffie-Hellman tuple. The REVEAL algorithm thus uses the private key of the OA to decrypt Φ_{venc} so as to expose g^{γ}^{₁}^{γ}^{₂}. Armed with the information traceᵢ=g^{γ}^{₁}^{γ}^{₂}, a tracing agent can test whether a ciphertext is prepared for user i as follows. It is required that each ciphertext contain tracability elements of the form (T₁,T₂,T₃)=(g^{δ}, [symbol] , [symbol] ) where δ, [symbol] ∈_{R} [symbol] ₚ are chosen by the sender. Since (Γ₁,Γ₂)=(g^{γ}^{₁},g^{γ}^{₂}), the TRACE algorithm concludes that user i is indeed the receiver if e(T₁,g^{γ}^{₁}^{γ}^{₂})=e(T₂,T₃). At the same time, it can be shown that recognizing ciphertexts encrypted for user i without traceᵢ is as hard as solving the Decision 3-party Diffie-Hellman (D3DH) problem [called BDDH in section 8 of D. Boneh and M. Franklin. Identity-Based Encryption from the Weil Pairing. SIAM Journal of Computing, vol. 32, no. 3, pp 586-615, 2003. Extended abstract in Crypto 2001, Lecture Notes in Computer Science 2139, pages 213-229, Springer, 2001].

An extra traceability component T₄ is introduced in the ciphertext; T₄=(Λ₀^{VK}·Λ₁)^{δ}, where Λ₀,Λ₁ ∈ [symbol] are part of common public parameters and VK is the verification key of a one-time signature. The reason for this is that, in order to prove anonymity in the considered model, the elements (T₁,T₂,T₃) need to be bound to the one-time verification key VK in a non-malleable way. Otherwise, an anonymity adversary would be able to break the anonymity by having access to a CLAIM/DISCLAIM oracle.

In order for user i to prove or disprove that it is the intended recipient of a given ciphertext-label pair (ψ, L), the user can use the traceability elements of the form (T₁,T₂,T₃)=(g^{δ}, [symbol] , [symbol] ) of the ciphertext ψ and its private key γ₁ to compute Γ₁^{δ}=T₁^{γ}^{₁} (even without knowledge of δ), which allows anyone to realize that (g,T₁,Γ₁,Γ₁^{δ}) forms a Diffie-Hellman tuple and that e(Γ₁^{δ}, Γ₂)=e(T₂,T₃). This is sufficient for proving that (ψ,L), was created for the public key pk=(X₁,X₂,Γ₁,Γ₂). In order to make sure that only the user will be able to compute non-interactive claims, it is also required that the user provide a non-interactive proof of knowledge of Γ₋₁=g^{1/γ}^{₁} satisfying e(Γ₁^{δ},Γ₋₁)=e(T₁,g). Moreover, the claim is non-malleably bound to (ψ,L), by generating the non-interactive Groth-Sahai proof [see J. Groth and A. Sahai. Efficient non-interactive proof systems for bilinear groups. In Eurocrypt'08, Lecture Notes in Computer Science 4965, pages 415-432, Springer, 2008] for a Common Reference String (CRS) which depends on (ψ,L) (this technique was originally described in [T. Malkin, I. Teranishi, Y. Vahlis, M. Yung. Signatures resilient to continual leakage on memory and computation. In TCC'11, Lecture Notes in Computer Science, vol. 6597, pp. 89-106, Springer, 2011.]).

### Preferred Embodiment

Like the scheme described by Cathalo-Libert-Yung [J. Cathalo, B. Libert, M. Yung. Group Encryption: Non-Interactive Realization in the Standard Model. In Asiacrypt'09, Lecture Notes in Computer Science 5912, pp. 179-196, Springer, 2009.], the preferred embodiment is a non-interactive group encryption scheme for the Diffie-Hellman relation [symbol] ={(A,B),M} where e(g,M)=e(A,B).

Unlike Cathalo-Libert-Yung's scheme, however, the present scheme provides extended tracing capabilities and further allows each user to non-interactively claim or disclaim that he is the intended recipient of a ciphertext.

The present scheme builds on the publicly verifiable variant of Cramer-Shoup [see the threshold variant of the Cramer-Shoup cryptosystem described in B. Libert, M. Yung. Non-Interactive CCA2-Secure Threshold Cryptosystems with Adaptive Security: New Framework and Constructions. In TCC 2012, Lecture Notes in Computer Science 7194, pp. 75-93, Springer, 2012.]. Advantage is taken of the observation that, if public key components (\vec{g₁},\vec{g₂},\vec{g₃}) are shared by all users as common public parameters, the scheme can simultaneously provide receiver anonymity and publicly verifiable ciphertexts. In other words, anyone can publicly verify that a ciphertext is a valid ciphertext without knowing who the receiver is. When proofs are generated for the group encryption ciphertext, this saves the prover from having to provide evidence that the ciphertext is valid and thus yields shorter proofs.

The message is encrypted under the receiver's public key using the scheme of Libert-Yung. At the same time, the last two components of the receiver's public key are encrypted under the public key of the opening authority using Kiltz's encryption scheme [see E. Kiltz. Chosen-ciphertext security from tag-based encryption. In TCC'06, Lecture Notes in Computer Science 3876, pages 581-600, Springer, 2006.]. This scheme is preferred because it is the most efficient Decision Linear (DLIN)-based CCA2-secure cryptosystem where the validity of ciphertexts is publicly verifiable and it is not needed to hide the public key under which it is generated.

When new users join the group, the GM provides them with a membership certificate consisting of a structure-preserving signature on their public key (X₁,X₂,Γ₁,Γ₂). In this case, the Abe-Haralambiev-Ohkubo (AHO) signature [briefly described in the Annexe; also see M. Abe, K. Haralambiev, M. Ohkubo. Signing on Elements in Bilinear Groups for Modular Protocol Design. Cryptology ePrint Archive: Report 2010/133, 2010. and M. Abe, G. Fuchsbauer, J. Groth, K. Haralambiev, M. Ohkubo. Structure-Preserving Signatures and Commitments to Group Elements. In Crypto'10, Lecture Notes in Computer Science 6223, pp. 209-236, Springer, 2010.] is used because it allows working exclusively with linear pairing-product equations (and thus obtain a better efficiency) when non-interactive proofs are generated.
SETUPᵢₙᵢₜ(λ): let l ∈ poly(λ) be a polynomial, where λ ∈ [symbol] is the security parameter. Generate public parameters as follows:

1. Choose bilinear groups ( [symbol] , [symbol] _{T}) of prime order p>2^{λ} with

$$g , {g}_{1} , {g}_{2} {}^{R} 𝔾 .$$

Define vectors \vec{g₁}=(g₁,1,g), \vec{g₂}=(1,g₂,g) and \vec{g₃}=\vec{g₁}^{ξ}^{₁} ⊙\vec{g₂}^{ξ}^{₂} with

$${ξ}_{1} , {ξ}_{2} {}^{R} {ℤ}_{p}^{*} ,$$

which form a perfectly sound Groth-Sahai common reference string g=(\vec{g₁},\vec{g₂},\vec{g₃}).

2. For i=1 to l choose

$${ζ}_{i , 1} , {ζ}_{i , 2} {←}^{R} {p}_{}$$

and set \vec{h}ᵢ=\vec{g₁}^{ζ}^{_{i,1}} ⊙ \vec{g₂}^{ζ}^{_{i,2}} so as to obtain a set of l+1 vectors {\vec{h}ᵢ}ᵢ₌₀^{l}.

3. Choose

$${η}_{1} , {η}_{2} {←}^{R} {p}_{}$$

and compute \vec{f}=\vec{g₁}^{η}^{₁} ⊙ \vec{g₂}^{η}^{₂}=(f_{3,1},f_{3,2},f_{3,3}) so as to form yet another Groth-Sahai CRS f=(\vec{g₁},\vec{g₂},\vec{f}).

4. Choose

$${Λ}_{0} , {Λ}_{1} {←}^{R}$$

at random.

5. Select a strongly unforgeable (as defined in [J. H. An, Y. Dodis, and T. Rabin. On the security of joint signature and encryption. In Eurocrypt'02, Lecture Notes in Computer Science 2332, pages 83-107, Springer, 2002.]) one-time signature scheme Σ=(G,S,V) and a random member H:{0,1}*→{0,1}^{l} of a collision-resistant hash family. (G is an algorithm that generates a one-time signature key pair, [symbol] is a signature algorithm and V is a signature verification algorithm.)

The public parameters param resulting from SETUPᵢₙᵢₜ(λ) comprise {λ, [symbol] , [symbol] _{T},g,\vec{g₁},\vec{g₂}, \vec{g₃},\vec{f},{\vec{h}ᵢ}ᵢ₌₀^{l},Λ₀,Λ₁,Σ,H}.
SETUP_{GM}(param): runs the setup algorithm of the AHO structure-preserving signature with n=4. The obtained public key comprises

pk_{GM}=(Gᵣ,Hᵤ,G_{z},H_{z}, {Gᵢ,Hᵢ}ᵢ₌₁⁴,Ωₐ,Ω_{b}) ∈ [symbol] ⁸× [symbol] _{T}²

while the corresponding private key is sk_{GM}=(αₐ,α_{b},γ_{z},δ_{z},{γᵢ,δᵢ}ᵢ₌₁⁴).
SETUP_{OA}(param): generates pk_{OA}=(Y₁,Y₂,Y₃,Y₄)=(g^{y}^{₁},g^{y}^{₂},g^{y}^{₃},g^{y}^{₄}), as a public key for Kiltz's encryption scheme, and the private key as sk_{OA}=(y₁,y₂,y₃,y⁴).
JOIN: the prospective user [symbol] ᵢ and the GM run the following protocol:

1. The user [symbol] ᵢ chooses

$${x}_{1} , {x}_{2} , z , {γ}_{1} , {γ}_{2} {←}^{R} {p}_{}$$

at random and computes a public key pk=(X₁,X₂,Γ₁,Γ₂) ∈ [symbol] ⁴ where

X₁=g₁^{x}^{₁}·g^{z}, X₂=g₂^{x}^{₂}·g^{z}, Γ₁=g^{y}^{₁}, Γ₂=g^{γ}^{₂}γg^{y}^{₂}.

The corresponding private key is defined to be sk=(x₁,x₂,z,y₁,y₂). Here, (X₁,X₂) form a public key for the Libert-Yung encryption scheme already mentioned whereas (Γ₁,Γ₂) will be used to provide user traceability.

2. User [symbol] ᵢ defines Γ₀=g^{γ}^{₁}^{γ}^{₂} and generates a verifiable encryption of Γ₀ under pk_{OA}. To this end, the user chooses

$${w}_{1} , {w}_{2} {←}^{R} {p}_{}$$

and computes Φ_{venc}=(Φ₀,Φ₁,Φ₂)=(Γ₀·g^{w}^{₁}^{+w}^{₂},Y₁^{w}^{₁},Y₂^{w}^{₂}).

User [symbol] ᵢ then generates a Non-Interactive Zero-Knowledge (NIZK) proof π_{venc} that Φ_{venc} encrypts Γ₀ ∈ [symbol] such that e(Γ₀,g)=e(Γ₁,Γ₂). Namely, user [symbol] ᵢ uses the CRS f=(\vec{g₁}, \vec{g₂}, \vec{f}) to generate Groth-Sahai commitments \vec{C}_{w}_{₁}, \vec{C}_{w}_{₂} to the group elements W₁=g^{w}^{₁} and W₂=g^{w}^{₂}, respectively, and to prove non-interactively that

e(Φ₀,g)=e(Γ₁,Γ₂)·e(g,W₁)·e(g,W₂)

e(Φ₁,g)=e(Y₁,W₁)

e(Φ₂,g)=e(Y₂,W₂)

These three equations are linear pairing product equations. However, since their proofs must be NIZK proofs, they cost 16 group elements to prove altogether (as the prover actually introduces an auxiliary variable [symbol] to prove that e(Φ₀,g)=e( [symbol] ,Γ₂)·e(g,W₁)·e(g,W₂) and [symbol] =Γ₁). π_{venc} denotes the resulting NIZK proof. The prospective user [symbol] ᵢ then sends the certification request comprising (pk=(X₁,X₂,Γ₁,Γ₂),Φ_{venc},\vec{C}_{w}_{₁},\vec{C}_{w}_{₂},π_{venc}) to the group manager GM.

3. If database already contains a record transcriptⱼ for which the certified public key pkⱼ=(X_{j,2},X_{j,2},Γ_{j,1},Γ_{j,2}) is such that e(Γ_{j,1},Γ_{j,2})=e(Γ₁,Γ₂), the GM returns ⊥. Otherwise, the GM generates a certificate certₚₖ=(Z,R,S,T,U,V,W) ∈ [symbol] ⁷ for pk, which consists of an AHO signature on the 4-uple (X₁,X₂,Γ₁,Γ₂). Then, the GM stores the entire interaction transcript

transcriptᵢ=(pk=(X₁,X₂,Γ₁,Γ₂), (Φ_{venc}, \vec{C}_{w}_{₁},\vec{C}_{w}_{₂},π_{venc}),certₚₖ)

in database. DATABASE-CHECK is an algorithm that allows running a sanity check on database. This algorithm returns 0 (meaning that database is not well-formed) if database contains two distinct records transcriptᵢ and transcriptⱼ for which the public keys pkᵢ=(X_{i,1},X_{i,2},Γ_{i,1},Γ_{i,2}) and pkⱼ=(X_{j,1},X_{j,2},Γ_{j,1},Γ_{j,2}) are such that e(Γ_{i,1},Γ_{i,2})=e(Γ_{j,1},Γ_{j,2}). Otherwise, it returns 1.
ENC(pk_{GM},pk_{OA},pk,certₚₖ,M,L): to encrypt M ∈ [symbol] such that ((A,B),M) ∈ [symbol] _{dh} (for public elements A,B ∈ [symbol] ), parse pk_{GM},pk_{OA} and pk as (X₁,X₂,Γ₁,Γ₂) ∈ [symbol] ⁴. Then:

1. Generate a one-time signature key pair (SK, VK)← [symbol] (λ).

2. Generate a tuple (T₁,T₂,T₃,T₄) ∈ [symbol] ⁴ of traceability components by choosing

$$δ , ϱ {←}^{R} {p}_{}$$

and computing

T₁=g^{δ} T₂=Γₜ^{δ/e} T₃=Γ₂^{e} T₄=(Λ₀^{VK}·Λ₁)^{δ}.

Compute a Libert-Yung encryption of M under the label L:

3. Generate a partial Libert-Yunq ciphertext:
a. Choose

$${θ}_{1} , {θ}_{2} {←}^{R} {p}_{}$$

and compute

C₀=M·X₁^{θ}^{₁}·X₂⁷⁴ ^{₂} C₁=g₁^{θ}^{₁} C₂=g₂^{θ}^{₂} C₃=g^{θ}^{₁}^{+θ}^{₂}.
b. Construct a vector \vec{g}_{VK}=\vec{g₃}·(1,1,g)^{VK} and use g_{VK}=(\vec{g₁},\vec{g₂}, \vec{g}_{VK})as a Groth-Sahai CRS to generate a NIZK proof that (g,g₁,g₂,C₁,C₂,C₃) form a valid tuple, by generating commitments \vec{C}_{θ}_{₁},\vec{C}_{θ}_{₂} to encryption exponents θ₁,θ₂ ∈ [symbol] ₚ (in other words, compute \vec{C}_{θ}_{ᵢ}=\vec{g}_{VK}^{θ}^{ᵢ}·\vec{g₁}^{r}^{ᵢ}·\vec{g₂}^{s}^{ᵢ}, with

$${r}_{i} , {s}_{i} {←}^{R} {p}_{}$$

for each i ∈ {1,2}) and a proof π_{LIN} that they satisfy

C₁=g₁^{θ}^{₁} C₂=g₂^{θ}^{₂} C₃=g^{θ}^{₁}^{+θ}^{₂}.
The whole proof consists of \vec{C}_{θ}_{₁},\vec{C}_{θ}_{₂} and π_{LIN} is obtained as

π_{LIN}=(π₁,π₂,π₃,π₄,π₅,π₆)=(g₁^{r}^{₁},g₁^{s}^{₁},g₂^{r}^{₂},g₂^{s}^{₂},g^{r}^{₁}^{+r}^{₂},g^{s}^{₁}^{+s}^{₂}).
c. Define the partial Libert-Yung ciphertext

ψ_{LY}=(C₀,C₁,C₂,C₃,\vec{C}_{θ}_{₁},\vec{C}_{θ}_{₂},π_{LIN}).

4. For i=1,2, choose

$${z}_{i , 1} , {z}_{i , 2} {←}^{R} {p}_{}$$

and encrypt Γᵢ under pk_{OA} using Kiltz's encryption scheme using the same one-time verification key VK as in step 1. Let {ψ_{K}_{ᵢ}}_{i=1,2} be the resulting ciphertexts.

5. Set the GE ciphertext ψ as ψ=VK∥(T₁,T₂,T₃,T₄)∥ψ_{LY}∥ψ_{K}_{₁}∥ψ_{K}_{₂}∥σ where σ is a one-time signature obtained as σ= [symbol] (SK, ((T₁,T₂,T₃,T₄)∥ψ_{LY}∥ψ_{K}_{₁}∥ψ_{K}_{₂}∥L)). [ [symbol] is described in SETUPᵢₙᵢₜ(λ) step 5.]

Return (ψ,L) and coins_{ψ} consist of δ, [symbol] ,{z_{i,1},z_{i,2}}_{i=1,2} and (θ₁,θ₂). If the one-time signature described by Groth [see J. Groth. Simulation-sound NIZK proofs for a practical language and constant size group signatures. In Asiacrypt'06, Lecture Notes in Computer Science 4284, pages 444-459, 2006.13] is used, VK and σ take 3 and 2 group elements, respectively, so that ψ consists of 35 group elements of [symbol] .
[symbol] (pk_{GM},pk_{OA},pk,certₚₖ, (X,Y),M,ψ,L,coins_{ψ}): parse pk_{GM}, pk_{OA}, pk and ψ as described. Using f=(\vec{g₁},\vec{g₂},\vec{f}) as a Groth-Sahai CRS, generate a non-interactive proof π_{ψ} for the ciphertext ψ. In the process hereinafter, all commitments and proofs are generated using the CRS f=(\vec{g₁},\vec{g₂},\vec{f}).

1. Parse the certificate certₚₖ as (Z,R,S,T,U,V,W) ∈ [symbol] ⁷ and re-randomize it to obtain (Z′,R′,S′,T′,U′,V′,W′)←ReRand(pk_{GM}, (Z,R,S,T,U,V,W)). Then, generate Groth-Sahai commitments \vec{C}_{z},\vec{C}_{R′},\vec{C}_{U′} to Z′, R′ and U′. The resulting overall commitment to certₚₖ consists of com_{cert}_{ₚₖ}=(\vec{C}_{z′}\vec{C}_{R′},\vec{C}_{U′},S′,T′,V′, W′) ∈ [symbol] ¹³.

2. Generate Groth-Sahai commitments to the components of the public key pk=(X₁,X₂,Γ₁,Γ₂) and obtain the set comₚₖ={\vec{C}_{X}_{₁},\vec{C}_{Γ}_{ᵢ}}_{i=1,2}, which consists of 12 group elements.

3. Generate a proof π_{cert}_{ₚₖ} that com_{cert}_{ₚₖ} is a commitment to a valid certificate for the public key contained in comₚₖ. The proof π_{cert}_{ₚₖ} is a non-interactive proof that committed group elements (Z′,R′,U′) satisfy the relations

Ωₐ·e(S′,T′)⁻¹·Πᵢ₌₁²e(Gᵢ,Xᵢ)⁻¹·Πᵢ₌₁²e(Gᵢ₊₂,Γᵢ)⁻¹=e(G_{z},Z′)·e(Gᵣ,R′),

Ω_{b}·e(V′,W′)⁻¹·Πᵢ₌₁²e(Hᵢ,Xᵢ)⁻¹·Πᵢ₌₁²e(Hᵢ₊₂,Γᵢ)⁻¹=e(H_{z},Z′)·e(Hᵤ,U′).

which cost 3 elements each. The whole proof π_{cert}_{ₚₖ} thus takes 6 group elements.

4. Generate a NIZK proof π_{T} that (T₁,T₂,T₃) satisfies (T₁,T₂,T₃)=(g^{δ}, [symbol] , [symbol] ) for some δ, [symbol] ∈ [symbol] ₚ. To this end, generate a commitment \vec{C}_{Υ} to the group element Υ= [symbol] and generate a NIZK proof that

e(Υ,T₃)=e(T₁,Γ₂) and

e(T₂,g)=e(Γ₁,Υ).

Since π_{T} must include \vec{C}_{Υ} and must be a NIZK proof, it requires 21 group elements. Specifically, 3 elements suffice for the first linear equation whereas the second requires to prove e(T₂,X_{T})=e(Γ₁,Υ) and e(X_{T},g)=e(g,g) using an auxiliary variable X_{T}=g.

5. For i=1,2, generate NIZK proofs π_{eq-key,i} that \vec{C}_{Γ}_{ᵢ} (which are part of comₚₖ) and ψ_{K}_{ᵢ} are encryptions of the same Γᵢ. If ψ_{K}_{ᵢ}=(V_{i,0},V_{i,1},V_{i,2},V_{i,3},V_{i,4}) comprises

(V_{i,0},V_{i,1},V_{i,2})=(Γᵢ·g^{z}^{_{i,1}}^{+z}^{_{i,2}},Y₁^{z}^{_{i,1}},Y₂^{z}^{_{i,2}})

and \vec{C}_{Γ}_{ᵢ} is parsed as (c_{Γ}_{ᵢ₁},c_{Γ}_{ᵢ₂},c_{Γ}_{ᵢ₃})=(g₁^{ρ}^{ᵢ₁}·f_{3,1}^{ρ}^{ᵢ₃},g₂^{ρ}^{ᵢ₂}·f_{3,2}^{ρ}^{ᵢ₃},Γᵢ·g^{ρ}^{ᵢ₁}^{+ρ}^{ᵢ₂}·f_{3,3}^{ρ}^{ᵢ₃}), where z_{i,1},z_{i,2} ∈ coins_{ψ},ρᵢ₁,ρᵢ₂,ρᵢ₃∈ [symbol] ₚ* and \vec{f}=(f_{3,1},f_{3,2},f_{3,3}), this amounts to prove knowledge of values z_{i,1},z_{i,2},ρᵢ₁,ρᵢ₂,ρᵢ₃ ∈ [symbol] ₚ* such that

$$( \frac{{V}_{i , 1}}{{c}_{{Γ}_{i 1}}} , \frac{{V}_{i , 2}}{{c}_{{Γ}_{i 2}}} , \frac{{V}_{i , 0}}{{c}_{{Γ}_{i 3}}} ) = ( \begin{matrix}{Y}_{1}^{{z}_{i , 1}} \cdot {g}_{1}^{- {ρ}_{i 1}} {f}_{3 , 1}^{- {ρ}_{i 3}} , {Y}_{2}^{{z}_{i , 2}} \cdot \\ {g}_{2}^{- {ρ}_{i 2}} {f}_{3 , 2}^{- {ρ}_{i 3}} , {g}^{{z}_{i , 1} + {z}_{i , 2} - {ρ}_{i , 1} - {ρ}_{i , 2}} \cdot {f}_{3 , 3}^{- {ρ}_{i 3}}\end{matrix} ) .$$

Committing to exponents z_{i,1},z_{i,2},ρᵢ₁,ρᵢ₂,ρᵢ₃ introduces 30 group elements whereas the above relations only require two elements each. Together with their corresponding commitments to {z_{i,1},z_{i,2},ρᵢ₁,ρᵢ₂,ρᵢ₃}_{i=1,2}, the proof element π_{eq-key,i} incurs 42 elements.

6. Generate a NIZK proof [symbol] that the ciphertext π_{LY} encrypts a group element M ∈ [symbol] such that ((A,B),M) ∈ [symbol] . To this end, generate a commitment

com_{M}=(c_{M,1},c_{M,2},c_{M,3})=(g₁^{ρ}^{₁}·f_{3,1}^{ρ}^{₃},g₂^{ρ}^{₂}·f_{3,2}^{ρ}^{₃},M·g^{ρ}^{₁}^{+ρ}^{₂}·f_{3,3}^{ρ}^{₃})

and prove that the underlying M is the same as the one for which C₀=M·X₁^{θ}^{₁}·X₂^{θ}^{₂} in ψ_{LY}. In other words, prove knowledge of exponents θ₁,θ₂,ρ₁,ρ₂,ρ₃ such that

$$( {C}_{1 } , {C}_{2} , \frac{{c}_{1}}{{c}_{M , 1}} , \frac{{c}_{2}}{{c}_{M , 2}} , \frac{{c}_{0}}{{c}_{M , 3}} ) = ( \begin{matrix}{g}_{1}^{θ} , {g}_{2}^{θ} , {g}_{1}^{{θ}_{1} - {ρ}_{1}} \cdot {f}_{3 , 1}^{- {ρ}_{3}} , {g}_{2}^{{θ}_{2} - {ρ}_{2}} \cdot \\ {f}_{3 , 2}^{- {ρ}_{3}} , {g}^{{ρ}_{1} - {ρ}_{2}} \cdot {f}_{3 , 3}^{- {ρ}_{3}} \cdot {X}_{1}^{{θ}_{1}} \cdot {X}_{2}^{{θ}_{2}}\end{matrix} ) .$$

Committing to θ₁,θ₂,ρ₁,ρ₂,ρ₃ takes 15 elements. Proving the first four relations of the equation requires 8 elements whereas the last one is quadratic and its proof is 9 elements. Proving the linear pairing-product relation e(g,M)=e(A,B) in NIZK demands 9 elements. (It requires the introduction of an auxiliary variable [symbol] and proof that e(g,M)=e( [symbol] ,B) and A= [symbol] , for variables M, [symbol] and constants g,A,B. The two proofs take 3 elements each and 3 elements are needed to commit to [symbol] .) Since it [symbol] includes com_{M}, it entails a total of 34 elements.

The entire proof π_{ψ}=com_{cert} _{ₚₖ} ∥comₚₖ∥π_{cert}_{ₚₖ}∥π_{T}∥π_{eq-key,1}∥π_{eq-key,2}∥π_{R} eventually takes 128 elements.
[symbol] (param,ψ,L,π_{ψ},pk_{GM},pk_{OA}): parse pk_{GM},pk_{OA},pk,ψ and π_{ψ} as already described. Return 1 if and only if the conditions below are all satisfied.

1. [symbol] (VK,σ,((T₁,T₂,T₃,T₄)∥ψ_{LY}∥ψₖ_{₁}∥ψ_{K}_{₂}∥L))=1.

2. The equality e(T₁,Λ₀^{VK}·Λ₁)=e(g,T₄) is satisfied and ψ_{LY} is a valid Libert-Yung ciphertext.

3. All proofs verify and ψ_{K}_{₁},ψ_{K}_{₂} are valid Kiltz encryption w.r.t. VK.
DEC(sk,ψ,L): parse ψ as VK∥(T₁,T₂,T₃,T₄)∥ψ_{LY}∥ψ_{K}_{₁}∥ψ_{K}_{₂}∥σ. Return ⊥ if either: (i) [symbol] (VK,σ,((T₁,T₂,T₃,T₄)∥ψ_{LY}∥ψ_{K}_{₁}∥ψ_{K}_{₂}∥L))=0, (ii) e(T₁,Λ₀^{VK}·Λ₁)≠e(g,T₄) or ψ_{LY} and {ψ_{K}_{ᵢ}}_{i=1,2} are not all valid ciphertexts. Otherwise, use sk to decrypt (ψ_{LY},L).
REVEAL(transcriptᵢ,sk_{OA}): parse transcriptᵢ as

((X_{i,1},X_{i,2},Γ_{i,1},Γ_{i,2}), (Φ_{venc,i},\vec{C}_{w}_{_{i,1}},\vec{C}_{w}_{_{i,2}},π_{venc,i}),cert_{pk,i}).

Parse Φ_{venc,i} as (Φ_{i,0},Φ_{i,1},Φ_{i,2}) ∈ [symbol] ³ and verify that (\vec{C}_{w}_{_{i,1}},\vec{C}_{w}_{_{i,2}},π_{venc,i}) form a valid proof for the linear pairing product statements in JOIN. If not, return ⊥. Otherwise, use sk_{OA}=(y₁,y₂,y₃,y₄) to compute Γ_{i,0}=Φ_{i,0}·Φ_{i,1}^{-1/y}^{₁}·Φ_{i,2}^{-1/y}^{₂}. Return the resulting plaintext traceᵢ=Γ_{i,0} ∈ [symbol] which can serve as a tracing trapdoor for user i as it is of the form Γ_{i,0}=Γ_{i,2}^{log}^{_{g}}^{(Γ}^{_{i,1}}⁾.
TRACE(pk_{GM},pk_{OA},ψ,traceᵢ): parse ψ as VK∥(T₁,T₂,T₃,T₄)∥ψ_{LY}∥ψ_{K}_{₁}∥ψ_{K}_{₂}∥σ and the tracing trapdoor traceᵢ as a group element Γ_{i,0} ∈ [symbol] . If the equality e(T₁,Γ_{i,0})=e(T₂,T₃) holds, it returns 1 (meaning that is indeed intended for user i). Otherwise, it outputs 0 (i.e., it is not intended for user i).
OPEN(sk_{OA},ψ,L): parse ψ as VK∥(T₁,T₂,T₃,T₄)∥ψ_{LY}∥ψ_{K}_{₁}∥ψ_{K}_{₂}∥σ. Return ⊥ if ψ_{K} is not a valid ciphertext w.r.t. VK or if [symbol] (VK,σ,((T₁,T₂,T₃,T₄)∥ψ_{LY}∥ψ_{K}_{₁}∥ψ_{K}_{₂}∥L))=0. Otherwise, decrypt {ψ_{K}_{ᵢ}}_{i=1,2} to obtain group elements Γ₁,Γ₂ ∈ [symbol] and look up database to find a record transcriptᵢ containing a public key pkᵢ=(X_{i,1},X_{i,2},Γ_{i,1},Γ_{i,2}) such that (Γ_{i,1},Γ_{i,2})=(Γ₁,Γ₂)—(it is to be noted that, unless database is ill-formed, such a record is unique if it exists). If such a record is found, output the matching i. Otherwise, output ⊥.
CLAIM/DISCLAIM(pk_{GM},pk_{OA},ψ,L,sk): parse ψ as VK∥(T₁,T₂,T₃,T₄)∥ψ_{LY}∥ψ_{K}_{₁}∥ψ_{K}_{₂}∥σ and the private key as sk=(x₁,x₂,z,y₁,y₂). To generate a claim/disclaimer τ for ψ. Compute T_{δ,1}=T₁^{γ}^{₁}=Γ₁^{δ}, where δ=log_{g}(T₁). Then, compute a collision-resistant hash v=H(ψ,L,pk) ∈ {0,1}^{l}. Then, parse v as v[1] . . . v[l] ∈ {0,1}^{l} and assemble the vector \vec{h}ᵥ=\vec{h}₀⊙ ⊙ᵢ₌₁^{l}\vec{h}ᵢ^{v|i|}. Using (\vec{g}₁,\vec{g}₂,\vec{h}ᵥ) as a Groth-Sahai CRS, generate a commitment \vec{C}_{Γ}_{_{−1}} to Γ₋₁=g^{1/γ}^{₁} and a NIZK proof that Γ₋₁ satisfies e(T_{δ,1},Γ₋₁)=e(T₁,g). To this end, generate a commitment \vec{C}_{χ}_{_{τ}} to the auxiliary variable χ_{τ}=g and non-interactive proofs π_{τ,1},π_{τ,2} for the equations

e(T_{δ,1},Γ₋₁)=e(T₁,χ_{τ}) e(g,χ_{τ})=e(g,g).

The claim/disclaimer τ consists of τ=(T_{δ,1},\vec{C}_{Γ}_{_{−1}},\vec{C}_{χ}_{_{τ}},π_{τ,1},π_{τ,2}) ∈ [symbol] ¹³.

The skilled person will appreciate that only group members using traceability components are able to claim or disclaim a ciphertext; indeed, Γ₋₁ serves this purpose.
CLAIM-VERIFY(pk_{GM},pk_{OA},ψ,L,pk,τ): parse ψ as VK∥(T₁,T₂,T₃,T₄)∥ψ_{LY}∥ψ_{K}_{₁}∥ψ_{K}_{₂}∥σ and the public key pk as (X₁,X₂,Γ₁,Γ₂). Parse τ as (T_{δ,1},\vec{C}_{Γ}_{_{−1}},\vec{C}_{χ}_{_{τ}},π_{τ,1},π_{τ,2}). Return 1 if and only if the relations

e(T_{67 ,1},Γ₂)=e(T₂,T₃) e(T₁,Γ₁)=e(g,T_{δ,1})

hold and π_{τ,1},π_{τ,2} are valid proofs for the relations e(T_{δ,1},Γ₋₁)=e(T₁,χ_{τ}) and e(g,χ_{τ})=e(g,g) w.r.t. the CRS (\vec{g}₁,\vec{g}₂,\vec{h}ᵥ), where \vec{h}ᵥ=\vec{h}₀⊙ ⊙ᵢ₌₁^{l}\vec{h}ᵢ^{v|i|} and v=H(ψ,L,pk) ∈ {0,1}^{l}.
DISCLAIM-VERIFY(pk_{GM},pk_{OA},ψ,L,pk,τ): parse ψ as VK∥(T₁,T₂,T₃,T₄)∥ψ_{LY}∥ψ_{K}_{₁}∥ψ_{K}_{₂}∥σ and the public key pk as (X₁,X₂,Γ₁,Γ₂). Parse τ as (T_{δ,1},\vec{C}_{Γ}_{_{−1}},\vec{C}_{χ}_{_{τ}},π_{τ,1},π_{τ,2}). Return 1 if and only if it holds that

e(T_{δ,1},Γ₂)≠e(T₂,T₃) e(T₁,Γ₁)=e(g,T_{δ,1})

and π_{τ,1},π_{τ,2} are valid proofs for the relations e(T_{δ,1},Γ₋₁)=e(T₁,χ_{τ}) and e(g,χ_{τ})=e(g,g) and the Groth-Sahai CRS (\vec{g}₁,\vec{g}₂,\vec{h}ᵥ), where \vec{h}ᵥ=\vec{h}₀ ⊙ ⊙ᵢ₌₁^{l}\vec{h}ᵢ^{v|i|} and v=H(ψ,L,pk) ∈ {0,1}^{l}.

From an efficiency point of view, the length of ciphertexts is about 2.18 kB in an implementation using symmetric pairings with a 512-bit representation for each group element (at the 128-bit security level), which is more compact than in the Paillier-based system of Kiayias-Tsiounis-Yung where ciphertexts already take 2.5 kB using 1024-bit moduli (and thus at the 80-bit security level). Moreover, the proofs only require 8 kB (against roughly 32 kB for the same security in Cathalo-Libert-Yung), which is significantly cheaper than in the original GE scheme of Kiayias-Tsiounis-Yung, where interactive proofs reach a communication cost of 70 kB to achieve a 2⁻⁵⁰ knowledge error.

Each feature disclosed in the description and (where appropriate) the claims and drawings may be provided independently or in any appropriate combination. Features described as being implemented in hardware may also be implemented in software, and vice versa. Reference numerals appearing in the claims are by way of illustration only and shall have no limiting effect on the scope of the claims.

### ANNEXE—AHO Structure-Preseving Signature Scheme

The description assumes public parameters pp=(( [symbol] , [symbol] _{T}),g) consisting of bilinear groups ( [symbol] , [symbol] _{T}) of prime order p>2^{λ}, where λ ∈ [symbol] and a generator g ∈ [symbol] .
Keygen (pp,n): given an upper bound n ∈ [symbol] on the number of group elements per signed message, choose generators

$${G}_{r} , {H}_{u} {←}^{R} 𝔾 .$$

### Pick

$${γ}_{z} , {δ}_{z} {←}^{R} {p}_{} and {γ}_{i} , {δ}_{i} {←}^{R} {p}_{} ,$$

for i=1 to n. Then, compute G_{z}=Gᵣ^{γ}^{_{z}}, H_{z}=Hᵤ^{δ}^{_{z}} and Gᵢ=Gᵣ^{y}^{ᵢ}, Hᵢ=Hᵤ^{δ}^{ᵢ} for each i ∈ {1, . . . , n}. Finally, choose

$${α}_{a} , {α}_{b} {←}^{R} {p}_{}$$

and defineΩₐ=e(Gᵣ,g^{α}^{ₐ}) and Ω_{b}=e(Hᵤ,g^{α}^{_{b}}). The public key is defined to be

pk=(Gᵣ,Hᵤ,G_{z},H_{z}, {Gᵢ,Hᵢ}ᵢ₌₁ⁿ,Ωₐ,Ω_{b}) ∈ [symbol] ²ⁿ⁺⁴× [symbol] _{T}²

while the private key is sk=(αₐ,α_{b},γ_{z},δ_{z},{γᵢ,δᵢ}ᵢ₌₁ⁿ).
Sign(sk, (M₁, . . . , Mₙ)): to sign a vector (M₁, . . . , Mₙ) ∈ [symbol] ⁿ using sk, choose

$$ζ , {ρ}_{a} , {ρ}_{b} , {ω}_{a} , {ω}_{b} {←}^{R} {p}_{}$$

and compute Z=g^{ζ} (as well as

$$R = {g}^{{ρ}_{a} - {γ}_{z} ζ} \cdot {\prod }_{i = 1}^{n} {M}_{i}^{- {γ}_{i}} , \\ S = {G}_{r}^{{ω}_{a}} , \\ T = {g}^{( {α}_{a} - {ρ}_{a} ) / {ω}_{a}} , \\ U = {g}^{{ρ}_{b} - {δ}_{z} ζ} \cdot {\prod }_{i = 1}^{n} {M}_{i}^{- {δ}_{i}} , \\ V = {H}_{u}^{{ω}_{b}} , \\ W = {g}^{( {α}_{b} - {ρ}_{b} ) / {ω}_{b}} .$$

The signature consists of a σ=(Z,R,S,T,U,V,W) ∈ [symbol] ⁷.
Verify(pk,σ,(M₁, . . . , Mₙ)): given a σ=(Z,R,S,T,U,V,W), return 1 if the following equalities hold:

$${Ω}_{a} = e ( {G}_{z} , Z ) \cdot e ( {G}_{r} , R ) \cdot e ( S , T ) \cdot {\prod }_{i = 1}^{n} e ( {G}_{i} , {M}_{i} ) , \\ {Ω}_{b} = e ( {H}_{z} , Z ) \cdot e ( {H}_{u} , U ) \cdot e ( V , W ) \cdot {\prod }_{i = 1}^{n} e ( {H}_{i} , {M}_{i} ) .$$

The scheme has been proved existentially unforgeable under chosen-message attacks under the so-called q-SFP assumption, where q is the number of signing queries.

Also, signature components {θᵢ}ᵢ₌₂⁷ can be publicly randomized to obtain a different signature (Z′,R′,S′,T′,U′,V′,W′)←ReRand(pk,σ) on (M₁, . . . , Mₙ). After randomization, Z′=Z while (R′,S′,T′,U′,V′,W′) are uniformly distributed among the values such that e(Gᵣ,R′)·e(S′,T′)=e(Gᵣ,R)·e(S,T) and e(Hᵤ,U′)·e(V′,W′)=e(Hᵤ,U)·e(V,W). This re-randomization is performed by choosing

$${ϱ}_{2} , {ϱ}_{5} , μ , ν {←}^{R} {p}_{}$$

and computing

R′=R· [symbol] , S′=(S· [symbol] )^{1/μ}, T′=T^{μ}

U′=U· [symbol] , V′=(V· [symbol] )^{1/ν}, W′=W^{ν}.

As a result, (S,T,V,W) are statistically independent of (M₁, . . . , Mₙ) and the rest of the signature. This implies that, in privacy-preserving protocols, re-randomized (S′,T′,V′,W′) can be safely given out as long as (M₁, . . . , Mₙ) and (Z′,R′,U′) are given in committed form.

1. A device for encrypting a plaintext destined for a user having a public key, the device comprising:
a processor configured to:
obtain a tuple of traceability components for first elements of the public key;
encrypt, using encryption exponents and second elements of the public key, the plaintext to obtain a first intermediary ciphertext;
generate commitments to the encryption exponents;
generate second intermediary ciphertexts by encrypting the first elements of the user's public key under a public key of an opening authority using a verification key; and
generate, using a signature key, a signature over the tuple of traceability components, the first intermediary ciphertext, and the second intermediary ciphertexts; and
an interface configured to output a ciphertext comprising the tuple of traceability components, the first intermediary ciphertext, the second intermediary ciphertexts, and the signature.

2. The device of claim 1, wherein the processor is configured to obtain the traceability components by calculating a plurality of values, wherein each value is obtained by taking a generator or an element of the public key to the power of a value involving at least one random number.

3. The device of claim 1, wherein the public key comprises a Diffie-Hellman instance and wherein the tracability components enable recognition of the public key through the solution to the Diffie-Hellman instance.

4. The device of claim 1, wherein the first intermediary ciphertext is obtained by multiplication between the plaintext and elements of the public key raised to the power of encryption exponents.

5. The device of claim 1, wherein the verification key is a verification key of a one-time signature scheme.

6. The device of claim 5, wherein the signature is a one-time signature obtained using the one-time signature scheme.

7. The device of claim 1, wherein the processor is further configured to generate the signature also over a label, and wherein the interface is further configured to output the label.

8. A method for encrypting a plaintext destined for a user having a public key, the method comprising, in a device:
obtaining, by a processor, a tuple of traceability components for first elements of the public key;
encrypting, by the processor using encryption exponents and second elements of the public key, the plaintext to obtain a first intermediary ciphertext;
generate, by the processor, commitments to the encryption exponents;
generate, by the processor, second intermediary ciphertexts by encrypting the first elements of the user's public key under a public key of an opening authority using a verification key; and
generate, by the processor using a signature key, a signature over the tuple of traceability components, the first intermediary ciphertext, and the second intermediary ciphertexts; and
outputting, by an interface, a ciphertext comprising the tuple of traceability components, the first intermediary ciphertext, the second intermediary ciphertexts, and the signature.

9. The method of claim 8, wherein the traceability components are obtained by calculating a plurality of values, wherein each value is obtained by taking a generator or an element of the public key to the power of a value involving at least one random number.

10. The method of claim 8, wherein the first intermediary ciphertext is obtained by multiplication between the plaintext and elements of the public key raised to the power of encryption exponents.

11. The method of claim 8, wherein the verification key is a verification key of a one-time signature scheme.

12. The method of claim 11, wherein the signature is a one-time signature obtained using the one-time signature scheme.

13. The method of claim 8, wherein the signature is generated also over a label, and wherein the label is further output by the interface.

14. Computer program product which is stored on a non-transitory computer readable medium and comprises program code instructions executable by a processor for implementing the steps of a method according to claim 8.
